(19) United States
(12) Patent Application Publication
(10) Pub. No.: US 2018/0088700 A1
(43) Pub. Date: Mar. 29, 2018

(54) PLUG-IN TOUCH DISPLAY WITH PRESSURE SENSING FUNCTION

(71) Applicant: Wuhan China Star Optoelectronics Technology Co., Ltd., Wuhan, Hubei (CN)

(72) Inventors: Chang CAO, Shenzhen, Guangdong (CN); Yu-cheng TSAI, Shenzhen, Guangdong (CN); Zhou ZHANG, Shenzhen, Guangdong (CN); Changwen MA, Shenzhen, Guangdong (CN)

(73) Assignee: Wuhan China Star Optoelectronics Technology Co., Ltd., Wuhan, Hubei (CN)

(21) Appl. No.: 15/301,348

(22) PCT Filed: May 24, 2016
(86) PCT No.: PCT/CN2016/083074

§ 371 Date: Sep. 30, 2016

(30) Foreign Application Priority Data
May 4, 2016 (CN) 201610288968.8

(51) Int. Cl. G06F 3/044; G06F 3/041; G02F 1/1335; G02F 1/1333

(52) U.S. Cl. CPC G06F 3/044; G06F 3/0412; G02F 1/133528; G06F 2203/04112; G02F 1/133514; G06F 3/0414; G02F 1/133602; G02F 1/13338

(57) ABSTRACT

The present disclosure proposes a plug-in touch display with a pressure sensing function. The touch display includes a capacitive touch screen to sense a touch and a display module includes a display panel having conductive layers which one of the conductive layers is configured to be used as a first capacitive sensing electrode, a backlight module positioned oppositely to the display panel, and a middle frame, configured to support the display panel and the backlight module. A second capacitive sensing electrode is positioned at a side of the middle frame, which is toward the backlight module. A gap exists between the second capacitive sensing electrode and the backlight module. The first capacitive sensing electrode and the second capacitive sensing electrode forms a capacitive sensing structure for sensing a pressure applied on the capacitive touch panel. This structure is compact and easy to produce and thus reduces the manufacturing expenses.

### BACKGROUND OF THE INVENTION

### 1. Field of the Invention

The invention relates to a display, and more particularly, to a plug-in touch display with a pressure sensing function.

### 2. Description of the Prior Art

As the development and the progress of portable electronic products, touch panels become more important. There are different types of touch sensing techniques. One of them is capacitive touch screen, which identifies the position information of a touching finger (through obtaining the capacitance differences of electrodes along the x-axis and y-axis direction). Because the demands of the touch sensing accuracies increase, the touch screen needs to sense the two dimensional position information, but also the vertical touching pressure (in the z-axis direction) in order to realize a three dimensional touching sensing mode instead of a conventional two dimensional touching sensing mode.

However, a conventional touching sensing device with pressure sensing function often additionally embodies a plurality of pressure sensors in the display (for example, a liquid crystal display). This design needs to change the structure of the display and makes the structure more complex and more difficult to produce. In addition, the pressure sensor only has limited resolution. However, when a plurality of pressure sensors are added, the display quality of the display is influenced.

### SUMMARY OF THE INVENTION

It is therefore one of the primary objectives of the claimed invention to provide a plug-in touching display, which utilizes a simple structure to realize the pressure sensing function and reduces the costs.

According to an exemplary embodiment of the claimed invention, a plug-in touch display with a pressure sensing function is provided. The plug-in touch display comprises: a capacitive touch screen, configured to sense a touch; a display module, wherein the display module and the capacitive touch screen are positioned in stacks, the display module comprising: a display panel, comprising a plurality of conductive layers, wherein one of the conductive layers is configured to be used as a first capacitive sensing electrode; a backlight module, positioned oppositely to the display panel; and a middle frame, configured to support the display panel and the backlight module; and a second capacitive sensing electrode, positioned at a side of the middle frame, which is toward the backlight module, wherein a gap exists between the second capacitive sensing electrode and the backlight module, the first capacitive sensing electrode and the second capacitive sensing electrode forms a capacitive sensing structure for sensing a pressure applied on the capacitive touch panel.

Furthermore, the display panel comprises a matrix substrate. The matrix substrate comprises a common electrode layer. The common electrode layer is configured to be used as the first capacitive sensing electrode and further configured to transfer a common voltage signal and a pressure sensing signal in a time-interleaved way within a frame time.

Furthermore, the display panel comprises a matrix substrate. One side of the display panel, which is toward the backlight module, has a first polarizer. The first polarizer is implemented with a conductive material and configured to be used as the first capacitive sensing electrode.

Furthermore, the display panel includes a matrix substrate. The matrix substrate includes a first polarizer and a first glass substrate in an order away from the backlight. The first polarizer is implemented with an insulating material. A first conductive surface is positioned between the first polarizer and the first glass substrate and used as a first capacitive sensing electrode.

Furthermore, the first conductive surface is implemented with ITO.

Furthermore, the second capacitive sensing electrode is implemented with ITO.

Furthermore, the display panel comprises a matrix substrate, a color filter substrate, and a liquid crystal layer between the matrix substrate and the color filter substrate, and the matrix substrate and the color filter substrate are positioned oppositely.

Furthermore, the capacitive touch screen comprises a touch driving electrode and a touch sensing electrode, which are positioned in different layers, and the touch driving electrode and the touch sensing electrode are configured to sense the touch applied on the capacitive touch screen.

According to an exemplary embodiment of the claimed invention, a plug-in touch display with a pressure sensing function is provided. The plug-in touch display comprises a capacitive touch screen and a display module positioned in stacks. The capacitive touch screen is configured to sense a touch. The capacitive touch screen comprises a touch driving electrode and a touch sensing electrode positioned in stacks. The display module comprises a display panel and a color filter substrate. A gap exists between the capacitive touch screen and the display module. The color filter substrate comprises a second polarizer and a second glass substrate in an order away from the capacitive touch screen. The second polarizer is implemented with an insulating material. A second conductive surface is positioned between the second polarizer and the second glass substrate, and the second conductive surface and the touch driving electrode form a capacitive sensing structure for sensing a pressure applied on the capacitive touch screen.

Furthermore, the second conductive surface is implemented with ITO.

In contrast to the related art, the plug-in touch display according to the exemplary embodiments adds a second capacitive sensing electrode between the middle frame and the backlight module to a conventional plug-in touch display. In addition, the plug-in touch display according to the exemplary embodiments utilizes a conductive layer as the first capacitive sensing electrode. In this way, the first and the second capacitive sensing electrodes form a capacitive sensing structure to detect the pressure applied on the capacitive sensing screen and thus realize the 3D touch sensing function. In addition, this structure is simple and easy to produce and thus reduces the manufacturing costs. Furthermore, the added second capacitive electrode is implemented with ITO and positioned at the back of the backlight module. This arrangement can realize the 3D touch sensing function without affecting the display quality.

### BRIEF DESCRIPTION OF THE DRAWINGS

FIG. 1 is a diagram showing a structure of a plug-in touch display according to the first embodiment.

FIG. 2 is a diagram showing a structure of a plug-in touch display according to the second embodiment.

FIG. 3 is a diagram showing a structure of a plug-in touch display according to the third embodiment.

FIG. 4 is a diagram showing a structure of a plug-in touch display according to the fourth embodiment

### DETAILED DESCRIPTION OF THE PREFERRED EMBODIMENT

These and other objectives of the claimed invention will no doubt become obvious to those of ordinary skill in the art after reading the following detailed description of the preferred embodiment that is illustrated in the various figures and drawings.

In addition, in order to explain the exemplary embodiments, only the structures related to the embodiments are shown in the figures and the other details are omitted for simplicity.

### First Embodiment

Please refer to FIG. 1, which is a diagram showing a structure of a plug-in touch display according to a first exemplary embodiment. As shown in FIG. 1, the plug-in touch display comprises a capacitive touch screen 1 and a display module 2, which are positioned in stacks.

The capacitive touch screen 1 comprises a touch-driven electrode 11 and a touch sensing electrode 12. The touch-driven electrode 11 and the touch sensing electrode 12 are used to sense a touch applied on the capacitive touch screen 1.

The display module 2 comprises a display panel 2a and a backlight module 2b, which are positioned oppositely. In addition, the display module 2 further comprises a middle frame 2c for supporting the display panel 2a and the backlight module 2b. The backlight module 2b provides lights to the display panel 2a to allow the display panel 2a to display images.

The display panel 2a comprises a matrix substrate 21 and a light filtering substrate 22, which are positioned oppositely. In addition, the display panel 2a further comprises a liquid crystal layer, between the matrix substrate 21 and the light filtering substrate 22. The matrix substrate 21 comprises a first glass substrate 211. A pixel electrode layer 212 and a common electrode layer 213 are orderly positioned at a side of the glass substrate 211, which is close to the liquid crystal layer 23. The first polarizer 214 is positioned at another side of the first glass substrate 211, which is close to the backlight module 2b. The pixel electrode layer 212 and the common electrode layer 213 are insulated to each other. (no insulating structure is shown in FIG. 1) The pixel electrode layer 212 comprises pixel electrodes arranged in a matrix. The color filter substrate 22 comprises a second glass substrate 221 and a color filtering layer 222. The color filtering layer 222 is positioned at a side of the second glass substrate 222, which is close to the liquid crystal layer 23. The color filtering layer 222 comprises a red resistor R, a green resistor G, and a blue resistor B. The second polarizer 223 is positioned at another side of the glass substrate 221, which is close to the capacitive touch screen 1. The matrix substrate 21 further comprises data lines, scan lines, and thin film transistors. The color filter substrate 22 further comprises a black matrix. These structures are not closely related to this embodiment and thus omitted here.

As shown in FIG. 1, a second capacitive sensing electrode 3 is positioned at a side of the middle frame 2c, which is toward to the backlight module 2b. There is a gap H1 between the second capacitive sensing electrode 3 and the backlight module 2b. The gap H1 is used to make sure that there is enough shape-changing space when the touch display is being touched (pressed). The second capacitive sensing electrode 3 is implemented with Indium Tin Oxide (ITO). In addition, the common electrode layer 213 is used as a first capacitive sensing electrode 4a. The first capacitive sensing electrode 4a and the second electrode sensing electrode 3 form a capacitive sensing structure C1 for sensing a pressure applied on the capacitive touch screen 1 of the touch display. Because the common electrode layer 213 is used as the first capacitive sensing electrode 4a, the common electrode 213 is used for transferring the common voltage signal and the pressure sensing signal in a time-shared manner within a frame time.

The capacitive touch screen is electrically connected to a touch control chip (not shown). The display panel 2a is electrically connected to a driver chip (not shown). The capacitive sensing structure C1 is electrically connected to a pressure sensing chip (not shown). The touch control chip, the driver chip, and the pressure sensing chip can be integrated into a printed circuit board and connected to corresponding components through flexible printed circuit (FPC). The touch control chip drives the touch driving electrode 11 and the touch sensing electrode 12 of the capacitive touch screen 1 to sense the position of the touch. Furthermore, within a frame time: In a display sequence, the common electrode layer 213 (the first capacitive sensing electrode 4a) transfers the common voltage signal to allow the display panel 2a to display an image. In the touch sequence, the common electrode 213 (the first capacitive sensing electrode 4a) transfers the pressure sensing signal. That is, when a finger touch the capacitive sensing screen 1, the display panel 2a changes its shape and the distance between the first capacitive electrode 4a and the second capacitive sensing electrode 3 becomes shorter such that the capacitance of the capacitive sensing structure C1 formed by the first capacitive electrode 4a and the second capacitive sensing electrode 3 changes. By establishing the correlations between the capacitance variance and the pressure value, the pressure sensing chip can obtain the pressure information by utilizing the capacitance variance such that the pressure sensing function can be realized. In this way, the touch display can realize the 3 dimensional touch sensing function.

The above embodiment adds a second capacitive sensing electrode between the middle frame and the backlight module to a conventional plug-in touch display with 2D touch sensing function. The second capacitive electrode and the common electrode form a capacitive sensing structure to sense the pressure applied on the display panel and thus realize the 3D touch sensing function. This structure is simple and easy to produce. Furthermore, the added capacitive sensing electrode is positioned at the back of the backlight module and thus could realize the 3D touch sensing function without affecting the display quality.

### Second Embodiment

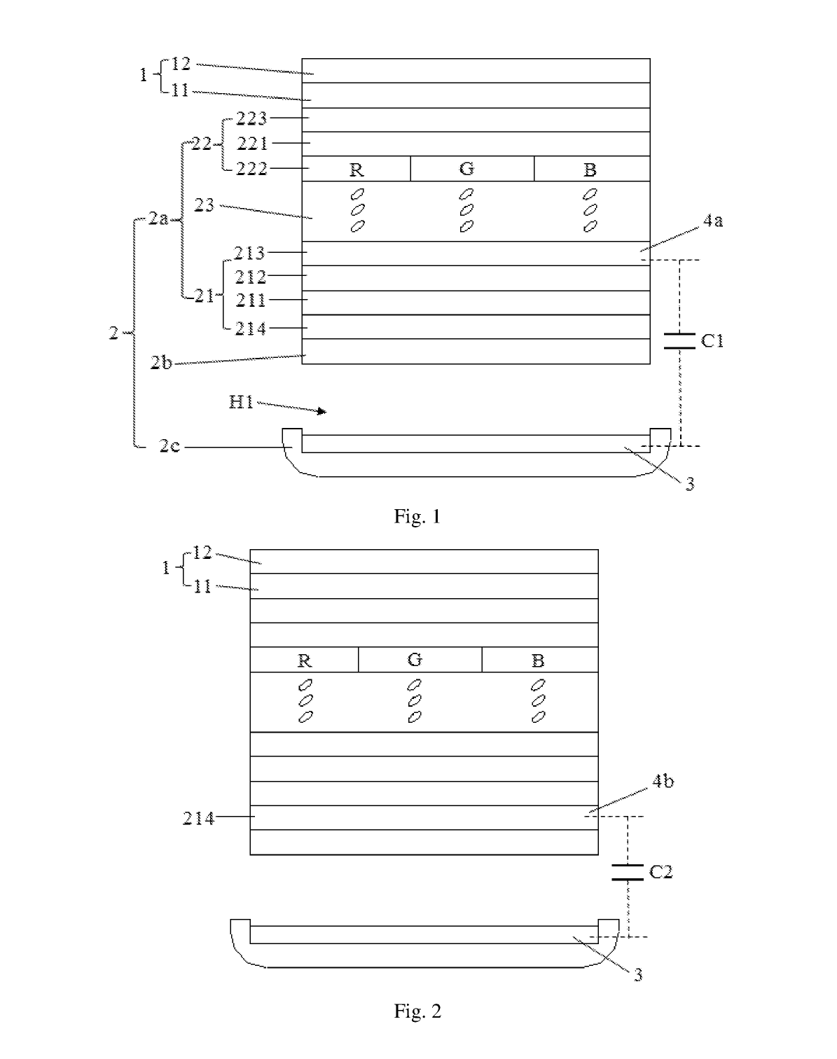

The difference between this embodiment and the first embodiment is: as shown in FIG. 2, the first polarizer 214 is implemented with the conductive material. The first polarizer 214 is used as the first capacitive sensing electrode 4b. The first capacitive sensing electrode 4b and the second capacitor sensing electrode 3 form a capacitive sensing structure C2. The capacitive sensing structure C2 is electrically connected to the pressure sensing chip (not shown) for sensing the pressure applied on the touch display.

Specifically, in the touch display, the touch driving electrode 11 and the touch sensing electrode 12, driven by the touch control chip, can detect the position of the touch. The touch sensing chip drives the first capacitive sensing electrode 4b and the second capacitive sensing electrode 3. When a finger touches the capacitive sensing screen 1, the distance between the first capacitive electrode 4b and the second capacitive sensing electrode 3 becomes shorter such that the capacitance of the capacitive sensing structure C2 formed by the first capacitive electrode 4b and the second capacitive sensing electrode 3 changes. By establishing the correlations between the capacitance variance and the pressure value, the pressure sensing chip can obtain the pressure information by utilizing the capacitance variance such that the pressure sensing function can be realized. In this way, the touch display can realize the 3D touch sensing function.

### Third Embodiment

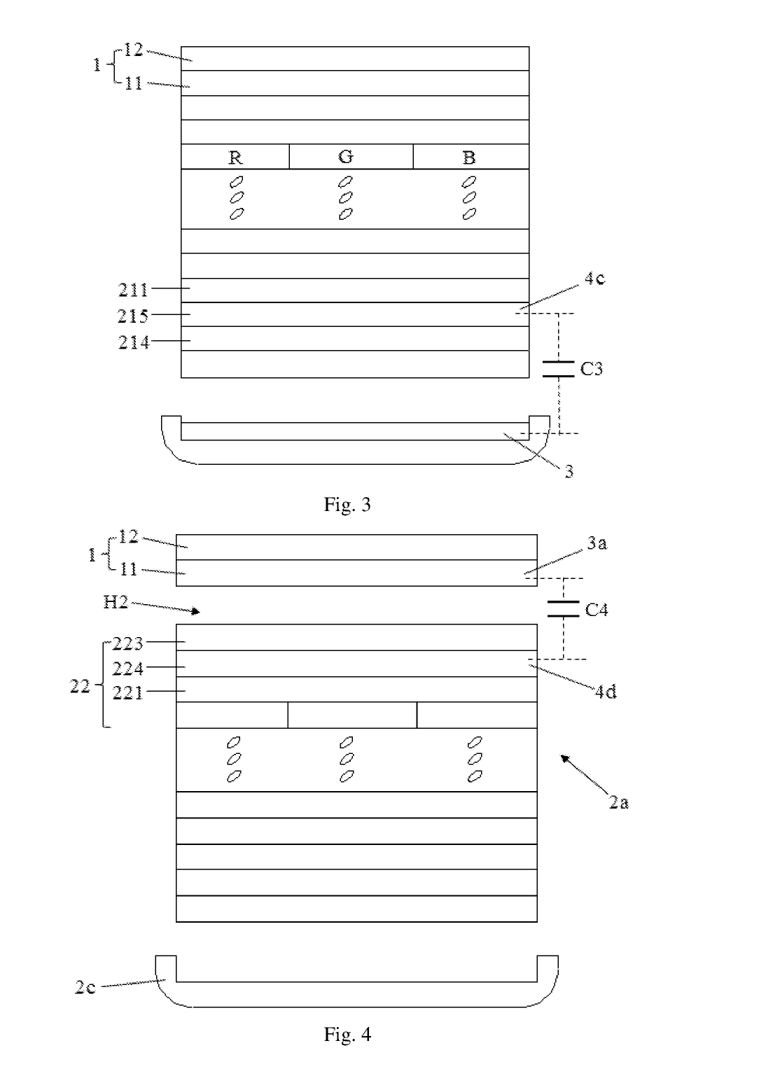

The difference between this embodiment and the first embodiment is: as shown in FIG. 3, a first conductive surface 215 is positioned between the first polarizer 214 and the first glass substrate 211. The first conductive surface 215 is used as the first capacitive sensing electrode 4b. The first capacitive sensing electrode 4c and the second capacitor sensing electrode 3 form a capacitive sensing structure C3. The capacitive sensing structure C2 is electrically connected to the pressure sensing chip (not shown) for sensing the pressure applied on the touch display. The first polarizer 214 is implemented with an insulating material and the first conductive surface 215 is implemented with ITO.

Specifically, in the touch display, the touch driving electrode 11 and the touch sensing electrode 12, driven by the touch control chip, can detect the position of the touch. The touch sensing chip drives the first capacitive sensing electrode 4c and the second capacitive sensing electrode 3. When a finger touches the capacitive sensing screen 1, the distance between the first capacitive electrode 4c and the second capacitive sensing electrode 3 becomes shorter such that the capacitance of the capacitive sensing structure C3 formed by the first capacitive electrode 4c and the second capacitive sensing electrode 3 changes. By establishing the correlations between the capacitance variance and the pressure value, the pressure sensing chip can obtain the pressure information by utilizing the capacitance variance such that the pressure sensing function can be realized. In this way, the touch display can realize the 3D touch sensing function.

### Fourth Embodiment

The difference between this embodiment and the first embodiment is: as shown in FIG. 4, the touch driving electrode 11 is used as the second capacitive sensing electrode 3a. Therefore, the middle frame 2c no longer has a second capacitive sensing electrode. There is a gap H2 between the capacitive touch screen 1 and the display panel 2a of the display module. Above the color filter substrate 22, a second conductive surface 224 is positioned between the second polarizer 223 and the second glass substrate 221. The second conductive surface 224 is used as the first capacitive sensing electrode 4d. The first capacitive sensing electrode 4d and the second capacitor sensing electrode 3a form a capacitive sensing structure C4. The capacitive sensing structure C4 is electrically connected to the pressure sensing chip (not shown) for sensing the pressure applied on the touch display. The second polarizer 223 is implemented with an insulating material and the second conductive surface 224 is implemented with ITO. The gap H2 can be an air gap or filled with optically clear adhesive (OCA).

Specifically, in the touch display, the entire touch control sequence can be divided into two parts. In the first touch control sequence, the touch driving electrode 11 (the second capacitive sensing electrode 3a) and the touch sensing electrode 12 detect the position of the touch. In the second touch control sequence, the touch sensing chip drives the first capacitive sensing electrode 4d and the touch driving electrode 11 (the second capacitive sensing electrode 3a). When a finger touches the capacitive sensing screen 1, the distance between the first capacitive electrode 4d and the second capacitive sensing electrode 3a becomes shorter such that the capacitance of the capacitive sensing structure C4 formed by the first capacitive electrode 4d and the second capacitive sensing electrode 3a changes. By establishing the correlations between the capacitance variance and the pressure value, the pressure sensing chip can obtain the pressure information by utilizing the capacitance variance such that the pressure sensing function can be realized. In this way, the touch display can realize the 3D touch sensing function.

From the above, the plug-in touch display according to the above embodiments has the first capacitive sensing electrode and the second capacitive sensing electrode to form the capacitive sensing structure. By obtaining the capacitance variance, the pressure information can be evaluated to realize the pressure sensing function. Therefore, the 3D touch sensing function could be realized without enormously changing the conventional touch display. This structure is more simple and easy to produce and thus reduces the manufacturing expenses.

The terms “a” or “an”, as used herein, are defined as one or more than one. The term “another”, as used herein, is defined as at least a second or more. The terms “including” and/or “having” as used herein, are defined as comprising. It should be noted that if it is described in the specification that one component is “connected,” “coupled” or “joined” to another component, a third component may be “connected,” “coupled,” and “joined” between the first and second components, although the first component may be directly connected, coupled or joined to the second component.

Those skilled in the art will readily observe that numerous modifications and alterations of the device may be made while retaining the teachings of the invention. Accordingly, the above disclosure should be construed as limited only by the metes and bounds of the appended claims.

What is claimed is:

1. A plug-in touch display with a pressure sensing function, the plug-in touch display comprising:
a capacitive touch screen, configured to sense a touch;
a display module, wherein the display module and the capacitive touch screen are positioned in stacks, the display module comprising:
a display panel, comprising a plurality of conductive layers, wherein one of the conductive layers is configured to be used as a first capacitive sensing electrode;
a backlight module, positioned oppositely to the display panel; and
a middle frame, configured to support the display panel and the backlight module; and
a second capacitive sensing electrode, positioned at a side of the middle frame, which is toward the backlight module,
wherein a gap exists between the second capacitive sensing electrode and the backlight module, the first capacitive sensing electrode and the second capacitive sensing electrode forms a capacitive sensing structure for sensing a pressure applied on the capacitive touch panel.

2. The plug-in touch display of claim 1, wherein the display panel comprises a matrix substrate, comprising a common electrode layer, wherein the common electrode layer is configured to be used as the first capacitive sensing electrode and further configured to transfer a common voltage signal and a pressure sensing signal in a time-interleaved way within a frame time.

3. The plug-in touch display of claim 1, wherein the display panel comprises a matrix substrate, one side of the display panel, which is toward the backlight module, has a first polarizer, and the first polarizer is implemented with a conductive material and configured to be used as the first capacitive sensing electrode.

4. The plug-in touch display of claim 1, wherein the second capacitive sensing electrode is implemented with Iridium Tin Oxide (ITO).

5. The plug-in touch display of claim 1, wherein the display panel comprises a matrix substrate, a color filter substrate, and a liquid crystal layer between the matrix substrate and the color filter substrate, and the matrix substrate and the color filter substrate are positioned oppositely.

7. The plug-in touch display of claim 1, wherein the capacitive touch screen comprises a touch driving electrode and a touch sensing electrode, which are positioned in different layers, and the touch driving electrode and the touch sensing electrode are configured to sense the touch applied on the capacitive touch screen.

8. A plug-in touch display with a pressure sensing function, the plug-in touch display comprising:
a capacitive touch screen, configured to sense a touch; and
a display module, wherein the display module and the capacitive touch screen are positioned in stacks, the display module comprising:
a display panel, comprising a plurality of conductive layers, wherein one of the conductive layers is configured to be used as a first capacitive sensing electrode;
a backlight module, positioned oppositely to the display panel; and
a middle frame, configured to support the display panel and the backlight module,
wherein the display panel comprises:
a matrix substrate, comprising a first polarizer and a first glass substrate in an order away from the backlight,
wherein the first polarizer is implemented with an insulating material, a first conductive surface is positioned between the first polarizer and the first glass substrate and used as a first capacitive sensing electrode, one side of the middle frame, which is toward the backlight module, has a second capacitive sensing electrode, a gap exist between the second capacitive sensing electrode and the backlight module, and the first capacitive sensing electrode and the second capacitive sensing electrode form a capacitive sensing structure configured to sense a pressure applied on the capacitive touch screen.

9. The plug-in touch display of claim 8, wherein the first conductive surface is implemented with ITO.

10. The plug-in touch display of claim 8, wherein the second capacitive sensing electrode is implemented with ITO.

11. The plug-in touch display of claim 8, wherein the display panel further comprises a color filter substrate positioned oppositely to the matrix substrate and a liquid crystal layer between the matrix substrate and the color filter substrate.

12. The plug-in touch display of claim 8, wherein the capacitive touch screen comprises a touch driving electrode and a touch sensing electrode, which are positioned in different layers, and the touch driving electrode and the touch sensing electrode are configured to sense the touch applied on the capacitive touch screen.

13. A plug-in touch display with a pressure sensing function, the plug-in touch display comprising:
a capacitive touch screen, configured to sense a touch, the capacitive touch screen comprising a touch driving electrode and a touch sensing electrode positioned in stacks; and
a display module, wherein the display module and the capacitive touch screen are positioned in stacks, the display module comprising a display panel,
wherein a gap exists between the capacitive touch screen and the display module, the display panel comprises a color filter substrate, the color filter substrate comprises a second polarizer and a second glass substrate in an order away from the capacitive touch screen, the second polarizer is implemented with an insulating material, a second conductive surface is positioned between the second polarizer and the second glass substrate, and the second conductive surface and the touch driving electrode form a capacitive sensing structure for sensing a pressure applied on the capacitive touch screen.

14. The plug-in touch display of claim 13, wherein the second conductive surface is implemented with ITO.

15. The plug-in touch display of claim 13, wherein the display panel comprises a matrix substrate, a color filter substrate, and a liquid crystal layer between the matrix substrate and the color filter substrate, and the matrix substrate and the color filter substrate are positioned oppositely.
